(19) United States
(12) Patent Application Publication
(10) Pub. No.: US 2011/0184697 A1
(43) Pub. Date: Jul. 28, 2011

(54) Coin sensor, effective value calculation method, and coin recognition device

(75) Inventor: Kazuya Tada, Hyogo (JP)

(73) Assignee: GLORY LTD.

(21) Appl. No.: 12/931,245

(22) Filed: Jan. 27, 2011

(30) Foreign Application Priority Data
Jan. 28, 2010 (JP) 2010-017039

(51) Int. Cl. G07D 5/04; G07D 5/02; G07D 5/08; G06F 15/00

(52) U.S. Cl. 702/173; 73/163

(57) ABSTRACT

A thickness/material sensor samples an output signal output from a self-oscillating circuit at a specific sampling interval; acquires sampling data sampled in a specific sampling time period; reduces, among the acquired sampling data, a weight on the sampling data sampled near both ends of the specific sampling time period than a weight on other sampling data and outputs weighted sampling data; and calculates effective values of an output signal in the specific sampling time period from the weighted sampling data.

### CROSS-REFERENCE TO RELATED APPLICATIONS

This application is based upon and claims the benefit of priority from Japanese Patent Application No. 2010-017039, filed on Jan. 28, 2010, the entire contents of which are incorporated herein by reference.

### BACKGROUND OF THE INVENTION

1. Field of the Invention

The present invention relates to a self-oscillating coin sensor that detects “material/thickness” (this expression means material or thickness, otherwise material and thickness) of a coin, an effective value calculation method for the coin sensor, and a coin recognition device including the coin sensor. More particularly, the present invention relates to a coin sensor that produces highly-accurate output results even when a frequency of an output signal fluctuates, an effective value calculation method for the coin sensor, and a coin recognition device including the coin sensor.

2. Description of the Related Art

Coin recognition devices that recognize denominations and authenticity of coins while the coins are being transported are known in the art. Such coin recognition devices recognize the coins based on detection of various properties such as diameter, thickness, and material of the coins by using various sensors.

A material/thickness sensor that employs an LC oscillation circuit is sometimes used as a sensor for detecting thicknesses of the coins (see, for example, Japanese Patent Application Laid-open No. 2000-187746) Concretely, the LC oscillation circuit outputs an output signal when a coin passes between coils. The material/thickness sensor calculates an average value of sampling data for a predetermined period extracted by smoothing the output signal of the LC oscillation circuit, and outputs the average value to the coin recognition device.

However, the conventional material/thickness sensor cannot detect the material/thickness of the coin with high accuracy. Concretely, because the target of evaluation in the conventional material/thickness sensor is the average value output, i.e., a direct current (DC) output, an output signal is delayed due to an influence of different offset for each circuit and a time constant RC of a smoothing circuit. One approach to address this issue is to perform an evaluation of the output signal based on effective values. In this approach, however, an output signal for a predetermined cycle cannot be accurately extracted even if effective values for a specific time can be calculated; because, a frequency of the output signal output from the LC oscillation circuit varies due to passing of the coins, temperature variations, and the like.

For example, assume that effective values are to be calculated from sampling data of output signals of 11 cycles. In this case, due to a variation in the frequency of the output signal, sometimes the effective values are calculated from sampling data of output signals of 11.5 or 10.5 cycles. Accuracy in calculation of the effective values degrades when an output wave for a specific cycle cannot be extracted, and consequently, accuracy in detection of the material/thickness of the coin degrades. One approach to take care of this issue is to monitor the frequency of the output signal, stop the sampling at a point in time of 11 cycles, and calculate the effective values from the acquired sampling data. Even in this approach, because an end of the sampling may not always coincide with an end of the 11th cycle, it is difficult to accurately sample the output signals of 11 cycles.

Thus, how to realize a coin sensor, an effective value calculation method, and a coin recognition device that produce highly-accurate output results even when a frequency of an output signal fluctuates has been a big problem.

### SUMMARY OF THE INVENTION

The present invention has been made in order to overcome the drawbacks of the above-mentioned conventional technology. An object of the present invention is to provide a coin sensor, an effective value calculation method, and a coin recognition device that produce highly-accurate output results even when a frequency of an output signal fluctuates.

According to an aspect of the present invention there is provided a coin sensor that magnetically detects a property of a coin. The coin sensor includes a self-oscillating circuit; a sampling unit that samples an output signal output from the self-oscillating circuit at a specific sampling interval; a data acquiring unit that acquires sampling data sampled by the sampling unit in a specific sampling time period; a weighting unit that, among the sampling data acquired by the data acquiring unit, reduces a weight on the sampling data sampled near both ends of the specific sampling time period than a weight on other sampling data and outputs weighted sampling data; and an effective value calculation unit that calculates effective values of the output signal in the specific sampling time period from the weighted sampling data.

According to another aspect of the present invention there is provided an effective value calculation method comprising a sampling step of sampling an output signal output from a self-oscillating circuit at a specific sampling interval; a data acquiring step of acquiring sampling data sampled at the sampling step in a specific sampling time period; a weighting step of reducing, among the sampling data acquired at the data acquiring step, a weight on the sampling data sampled near both ends of the specific sampling time period than a weight on other sampling data and outputting weighted sampling data; and an effective value calculation step of calculating effective values of the output signal in the specific sampling time period from the weighted sampling data.

According to still another aspect of the present invention there is provided a coin recognition device that includes plural types of sensors including a coin sensor. The coin recognition device includes a sampling unit that samples an output signal output from a self-oscillating circuit in the coin sensor at a specific sampling interval; a data acquiring unit that acquires sampling data sampled by the sampling unit in a specific sampling time period; a weighting unit that, among the sampling data acquired by the data acquiring unit, reduces a weight on the sampling data sampled near both ends of the specific sampling time period than a weight on other sampling data and outputs weighted sampling data; an effective value calculation unit that calculates effective values of the output signal in the specific sampling time period from the weighted sampling data; a material/thickness determination unit that determines a material/thickness of the coin from the effective values calculated by the effective value calculation unit; and a coin recognition unit that recognizes the coin by performing a multivariate analysis based on the material/thickness of the coin determined by the material/thickness determination unit and output results of the plural types of sensors.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are diagrams for explaining a concept of an effective value calculation method according to the present invention;

FIGS. 2A to 2C are external views of a coin recognition device according to an embodiment;

FIG. 3 depicts a configuration example of a material/thickness sensor;

FIGS. 4A and 4B depict situations in which a start and an end of a sampling time period have shifted from an ideal start and an ideal end;

FIGS. 5A to 5C depict examples of an application of a weight function to sampling data;

FIG. 6 depicts an example of an output waveform of the material/thickness sensor rendered by effective values;

FIG. 7 is a flowchart of operations of the material/thickness sensor;

FIGS. 8A and 8B are diagrams for explaining re-setting of the sampling time period;

FIG. 9 is a block diagram of a configuration of the coin recognition device;

FIG. 10 is a diagram for explaining a concept of a processing performed by the coin recognition device; and

FIG. 11 depicts an example of a denomination recognition based on a multivariate analysis by employing Mahalanobis' distance.

### DETAILED DESCRIPTION OF THE PREFERRED EMBODIMENTS

Exemplary embodiments of a coin sensor, an effective value calculation method, and a coin recognition device according to the present invention are explained below by referring to the accompanying diagrams.

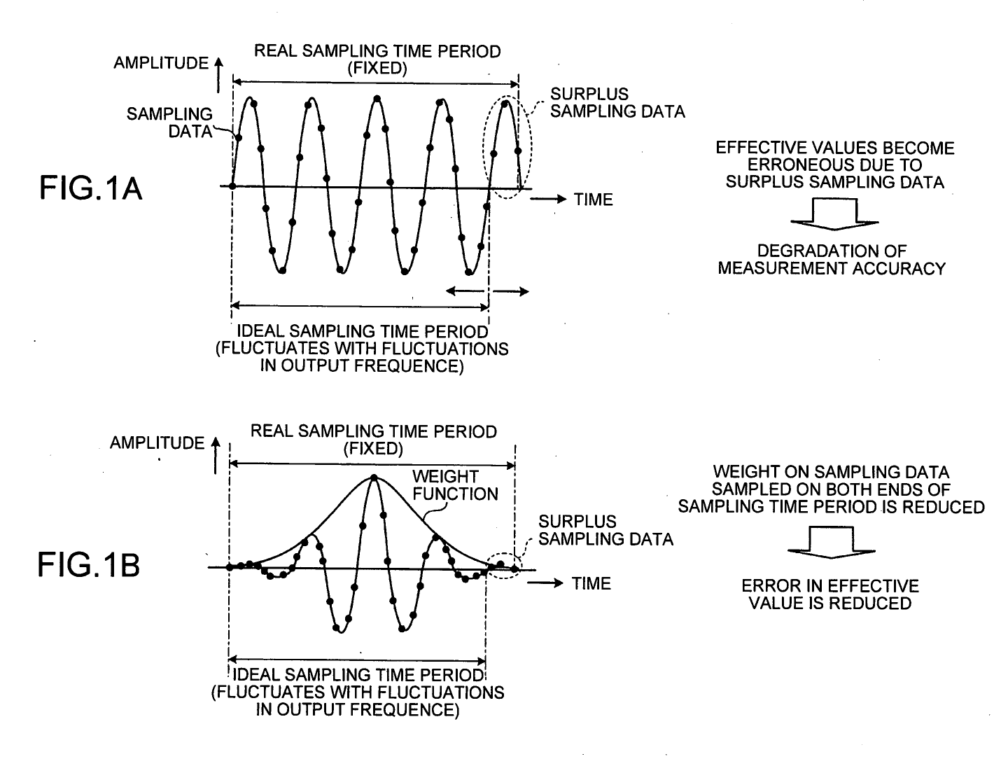

Before explaining the embodiments in detail, a concept of an effective value calculation method according to the present invention is explained by using FIGS. 1A and 1B. FIGS. 1A and 1B are diagrams for explaining the concept of the effective value calculation method according to the present invention. FIG. 1A depicts a concept of a conventional effective value calculation method, and FIG. 1B depicts the concept of the effective value calculation method according to the present invention.

As shown in FIG. 1B, one feature of the effective value calculation method according to the present invention is as follows. The feature is that, when calculating effective values from sampling data sampled in a specific period obtained by sampling an output signal (hereinafter, “detection signal”) output from a self-oscillating circuit, a weight on sampling data sampled near both ends of the specific period is set lower than a weight on other sampling data.

An effective value is an evaluation value of the detection signal (alternating current) that varies in a short cycle within a specific period. Concretely, the effective value is a mean square-root of square sums of sampling data (amplitude values) sampled in the specific period.

As shown in FIG. 1A, in the conventional effective value calculation method, the effective values are calculated for every specific period by sampling the detection signal output from the oscillation circuit for every time frame (for example, 500 microseconds (μs)). The specific period is referred below as a sampling time period.

To accurately calculate the effective values, it is desirable that the detection signal output from the oscillation circuit is extracted in a specific cycle. However, because the frequency of the detection signal output from the self-oscillating circuit fluctuates, as in the conventional effective value calculation method, when the detection signal is sampled for every specific time frame, the detection signal for the specific period cannot be extracted accurately.

More specifically, as shown in FIG. 1A, the sampling time period that is necessary to extract the detection signal for the specific period (hereinafter, “ideal sampling time period”) fluctuates with the fluctuations in the frequency of the detection signal. Consequently, as shown in FIG. 1A, when the ideal sampling time period is shorter than a real sampling time period, sampling data sampled from an end of the ideal sampling time period to an end of the real sampling time period is extracted unnecessarily as surplus sampling data.

When the effective values are calculated from the sampling data sampled in the ideal sampling time period as well as the surplus sampling data, erroneous effective values are obtained due to an influence of the surplus sampling data, leading to a degradation of a measurement accuracy. On the other hand, when the ideal sampling time period is longer than the real sampling time period, a deficiency in the sampling data occurs due to deficient sampling data, leading to problems similar to those described above.

A situation is explained so far in which the sampling data sampled near the end of the sampling time period causes the effective values to be erroneous when it is assumed that a start of the real sampling time period coincides with a start of the ideal sampling time period. However, in actual practice, because it is not always the case that the start of the ideal sampling time period and the start of the real sampling time period coincide with each other, the data sampled near the start of the sampling time period may cause the effective values to be erroneous.

In this manner, when the ideal sampling time period and the real sampling time period do not coincide with each other, the effective values of the detection signal become erroneous due to the influence of the sampling data sampled near both the ends of the sampling time period. Furthermore, because the frequency of the detection signal fluctuates randomly, it is difficult that the real sampling time period coincides with the ideal sampling time period. Even if the frequency of the detection signal is monitored, as long as the sampling is performed within the specific sampling interval, the end of the sampling may not coincide with the end of the ideal sampling time period; therefore, it is difficult to accurately extract the detection signal of the specific cycle.

In view of the above discussion, in the effective value calculation method according to the present invention, accuracy in a calculation of the effective values is improved by giving the sampling data sampled near both the ends of the sampling time period less weight on the result than the other sampling data.

Concretely, as shown in FIG. 1B, in the effective value calculation method according to the present invention, the sampling data sampled in the real sampling time period is multiplied by a specific weight function.

The weight function can be chosen such that it gives the sampling data sampled near both the ends of the sampling time period less weight on the result than the other sampling data. More desirably, a function whose slope becomes less steep toward the start and the end of the sampling time period can be chosen as the weight function.

For example, as shown in FIG. 1B, when the sampling data sampled in the real sampling time period is multiplied by the above-explained weight function, values of the sampling data sampled near both the ends of the real sampling time period sufficiently are reduced in comparison to those of the other sampling data. Therefore, the influence of these sampling data, sampled near the ends of the real sampling time period, on the effective values is reduced, and consequently, the accuracy in the calculation of the effective values can be improved.

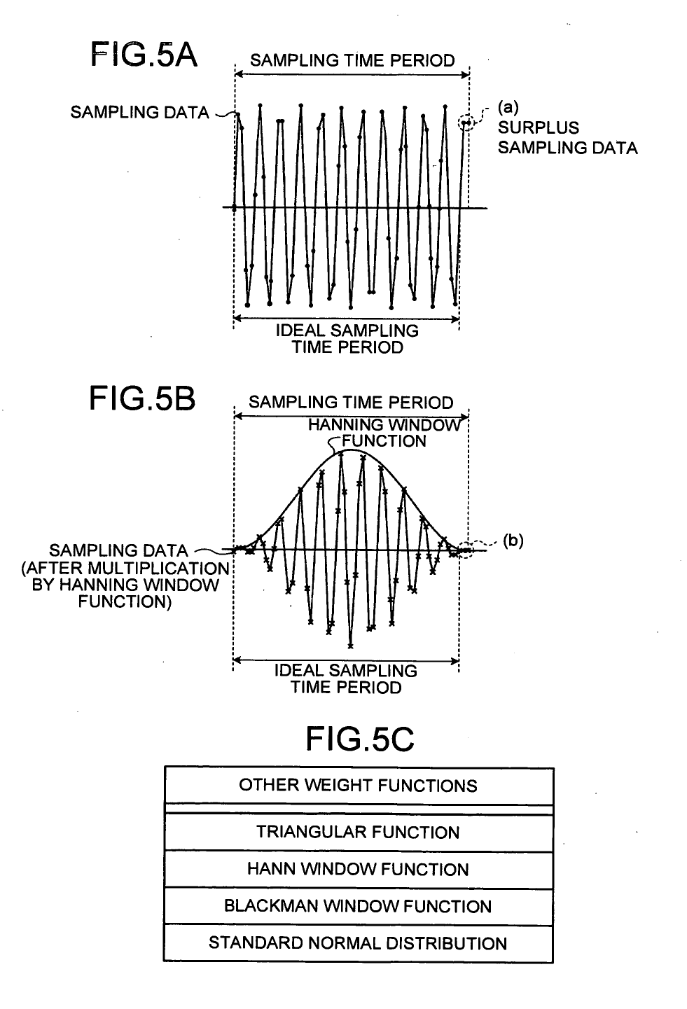

It is desirable that the weight function is a function that makes the values of the sampling data near the start and the end of the sampling time period zero, and that is symmetric about a center of the sampling time period, which is a so-called “window function”. For example, the Hanning window function can be used as such a window function. This point is explained in more detail by using FIGS. 5A to 5C.

In this manner, in the effective value calculation method according to the present invention, by giving the sampling data sampled near both the ends of the sampling time period less weight on the result than the other sampling data, accurate output results can be obtained not only when the amplitude of the detection signal fluctuates but also when the frequency of the detection signal fluctuates.

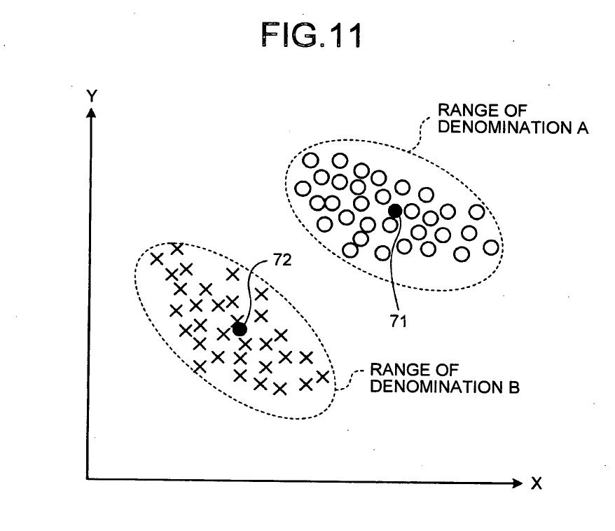

Meanwhile, by employing the output results (or evaluation values calculated from the output results) calculated by the effective value calculation method according to the present invention as one variable among variables in a multivariate analysis for a coin recognition, accuracy of the multivariate analysis can be improved. This point is explained in more detail by using FIG. 11.

Exemplary embodiments of a coin sensor, an effective value calculation method, and a coin recognition device to which the effective value calculation method explained by using FIG. 1B is applied are explained in detail below. The following embodiments explain a situation in which the coin sensor according to the present invention is applied to a material/thickness sensor that detects a thickness of an object, i.e., a coin; however, the coin sensor can be similarly applied to sensors other than a material sensor, a thickness sensor, and the material and thickness sensor. Furthermore, the following embodiments explain a coin recognition device that recognizes a coin by using a magnetic sensor, a milled-edge sensor, and a material/thickness sensor as the coin recognition device according to the present invention.

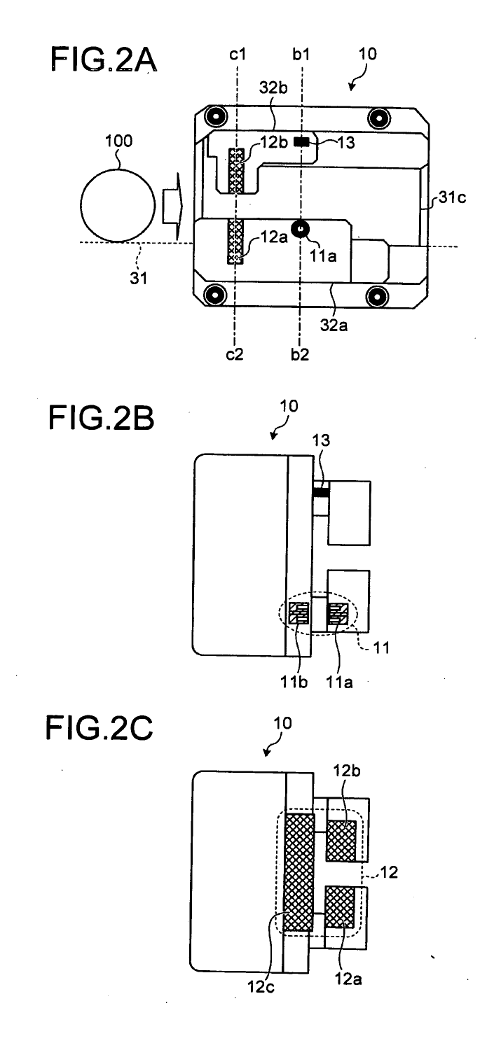

FIGS. 2A to 2C are external views of the coin recognition device 10 according to an embodiment. FIG. 2A is a sectional diagram of the coin recognition device 10 cut in a plane parallel to a transport plane of coins to facilitate an understanding of an arrangement of various sensors.

As shown in FIG. 2A, a coin 100 is transported to the coin recognition device 10 along a side wall of transport path 31 against which the coin is aligned. The coin 100 is then transported through a transport path formed by an upper surface 31c of a lower unit and lower surface of an upper unit of the coin recognition device 10. The upper unit includes a side aligning upper unit 32a and a counter-side aligning upper unit 32b.

A pod-core sensor 11a constituting a material/thickness sensor 11 (upper surface side) is arranged in a sectional plane b1-b2 of the side aligning upper unit 32a, and a milled-edge sensor 13 is arranged in the sectional plane b1-b2 between the counter-side aligning upper unit 32b and the lower unit.

An aligning side transmissive sensor 12a is arranged in a sectional plane c1-c2 of the side aligning upper unit 32a, and a counter-aligning side transmissive sensor 12b is arranged in the sectional plane c1-c2 of the counter-side aligning upper unit 32b.

As shown in FIG. 2B, the pod-core sensor 11a (upper surface side) is arranged in a sectional plane b1-b2 of the side aligning upper unit 32a, and a pod-core sensor 11b (lower surface side) is arranged in the lower unit. The pod-core sensor 11a (upper surface side) and the pod-core sensor 11b (lower surface side) are arranged opposite to each other with respect to the transport path therebetween. The material/thickness sensor 11 includes the pod-core sensor 11a (upper surface side) and the pod-core sensor 11b (lower surface side).

The pod-core sensor 11a (upper surface side) and the pod-core sensor 11b (lower surface side) are constituted by accommodating a wound coil in a not shown cylindrical casing. The milled-edge sensor 13 is a reflective photosensor. The milled-edge sensor 13 is arranged on a side wall of the transport path and it detects ridges and trenches (hereinafter, “milled edge”) on a periphery of the coin 100.

As shown in FIG. 2C, an excitation coil 12c for exciting the aligning side transmissive sensor 12a and the counter-aligning side transmissive sensor 12b is arranged in the sectional plane c1-c2 of the lower unit. A magnetic sensor 12 includes the aligning side transmissive sensor 12a, the counter-aligning side transmissive sensor 12b, and the excitation coil 12c.

The coin recognition device 10 according to the present embodiment uses detection results of the material/thickness sensor 11, the magnetic sensor 12, and the milled-edge sensor 13 to perform the multivariate analysis for recognizing the coin 100. Particularly, in the present embodiment, the accuracy in the recognition of the coin 100 in the multivariate analysis can be improved by improving the accuracy in the calculation of the effective values that are output results of the material/thickness sensor 11.

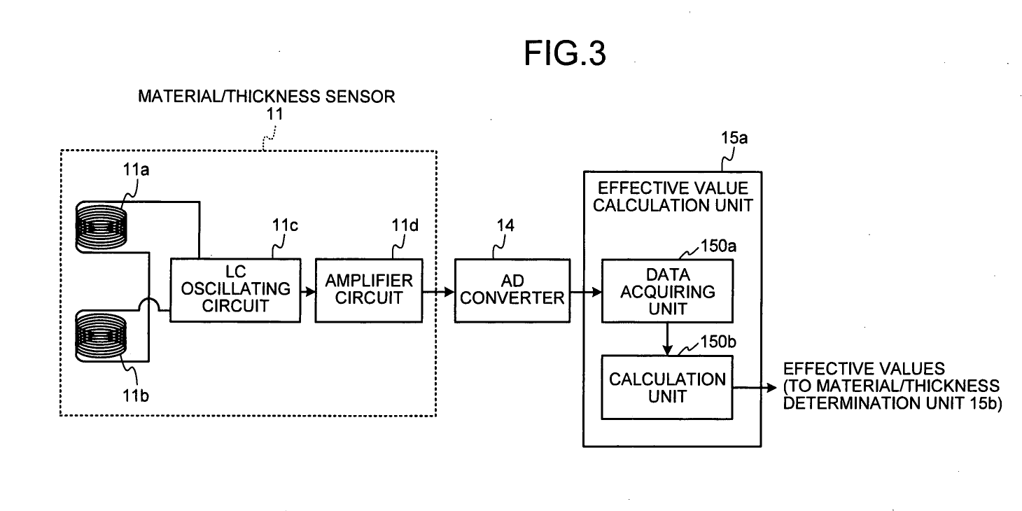

A configuration of the material/thickness sensor 11 according to the present embodiment is explained by using FIG. 3. FIG. 3 depicts a configuration example of the material/thickness sensor 11. Only those structural elements that are necessary for explaining features of the material/thickness sensor 11 are shown in FIG. 3, and general structural elements have been omitted.

The material/thickness sensor 11 is a coin sensor that magnetically detects a material and thickness of a coin, which are one portion of the properties of the coin. As shown in FIG. 3, the material/thickness sensor 11 includes the pod-core sensor 11a (upper surface side), the pod-core sensor 11b (lower surface side), an LC oscillation circuit 11c, and an amplifier circuit lid.

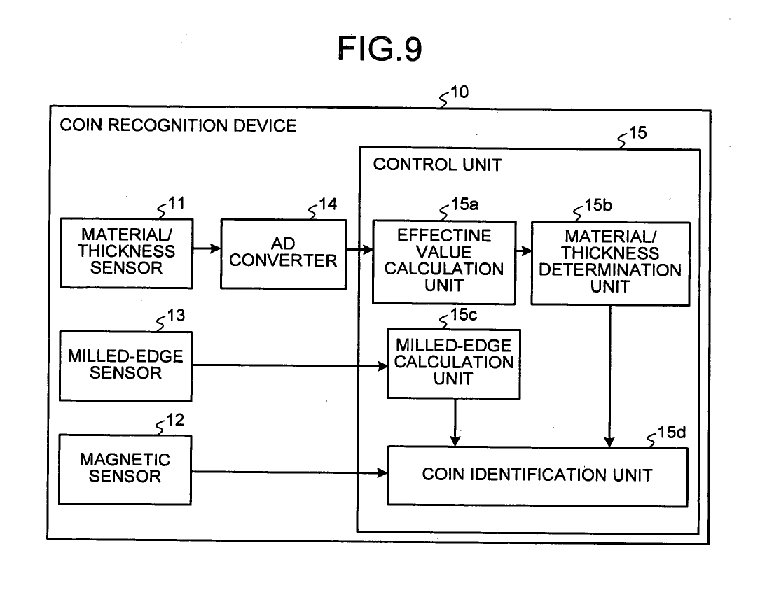

The material/thickness sensor 11, an AD (Analog-to-Digital) converter 14, and an effective value calculation unit 15a are part of the structural elements of the coin recognition device 10. Meanwhile, a situation is explained in which the coin recognition device 10 includes the effective value calculation unit 15a; however, a configuration is permissible in which the material/thickness sensor 11 includes the effective value calculation unit 15a. A concrete configuration of the coin recognition device 10 is explained later by using FIG. 9.

In the material/thickness sensor 11, the pod-core sensor 11a (upper surface side) and the pod-core sensor 11b (lower surface side) are connected in series, and the pod-core sensor 11a (upper surface side) and the pod-core sensor 11b (lower surface side) are connected to the LC oscillation circuit 11c. Meanwhile, the pod-core sensor 11a (coil) and the pod-core sensor 11b (coil) are reverse-phase connected in series such that their mutual inductance is negative; therefore, the LC oscillation circuit 11c can be caused to function as the thickness sensor. In contrast, when the pod-core sensors 11a and 11b are in-phase connected in series such that their mutual inductance is positive, the LC oscillation circuit 11c can be made to function as the material sensor. However, both functions of the thickness sensor and material sensor are not separated completely.

A detection signal output by the LC oscillation circuit 11c is amplified by the amplifier circuit 11d and the amplified detection signal is output to the AD converter 14. The AD converter 14 samples the amplified detection signal received from the amplifier circuit 11d at a specific sampling interval for every specific time frame and outputs the obtained sampling data to a data acquiring unit 150a of the effective value calculation unit 15a.

Concretely, the AD converter 14 performs the sampling at a sampling interval of 2 μs during every 500 μs. In actual practice, the AD converter 14 performs the sampling in only an anterior part of 256 μs out of 500 μs. In other words, this anterior part of 256 μs is the sampling time period.

When the coin 100 reaches between the pod-core sensors 11a and 11b, the amplitude of the detection signal output to the AD converter 14 is reduced. The coin recognition device 10 detects the thickness of the coin from a change in the amplitude of the detection signal. Meanwhile, not only the amplitude of the detection signal is reduced when the coin 100 passes between the pod-core sensors 11a and 11b, and the frequency of the detection signal also fluctuates. Therefore, the start and/or the end of the sampling time period shift from the start and/or the end of the ideal sampling time period (for example, there is the detection signal of 11 cycles between the start and end of a sampling time period).

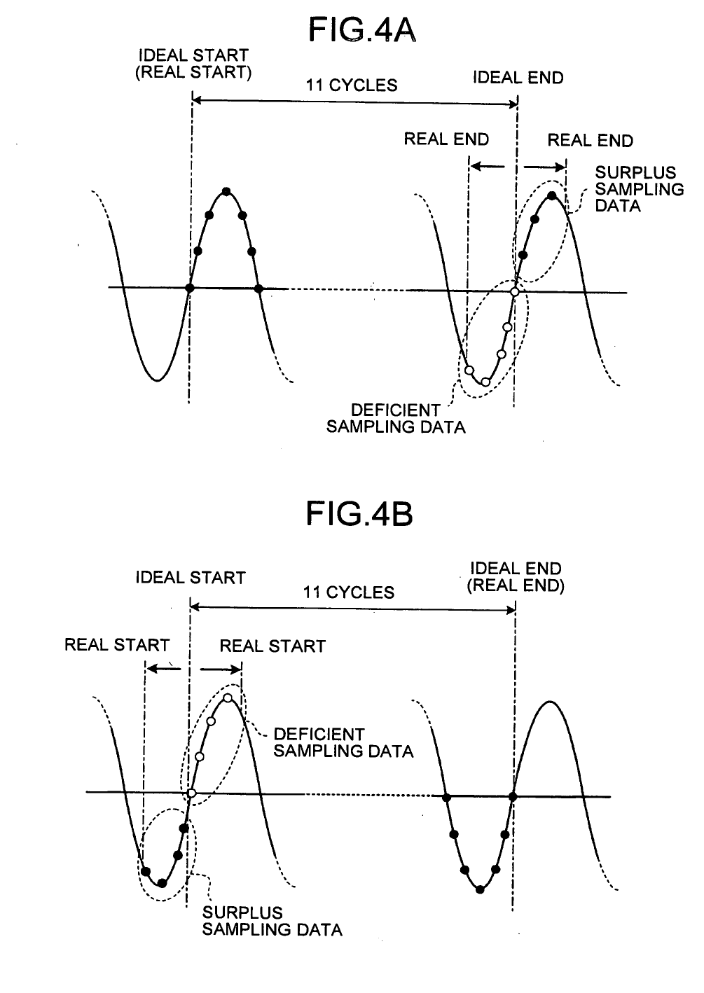

This issue is explained by using FIGS. 4A and 4B. FIGS. 4A and 4B depict situations in which the start and the end of the sampling time period have shifted from an ideal start and an ideal end. FIG. 4A depicts a situation in which the start of the sampling time period coincides with the ideal start but the end of the sampling time period has shifted from the ideal end, and FIG. 4B depicts a situation in which the end of the sampling time period coincides with the ideal end but the start of the sampling time period has shifted from the ideal start.

Because the ideal sampling time period fluctuates with the fluctuations in the frequency of the detection signal, as shown in FIG. 4A, even when the start of the sampling time period coincides with the ideal start, it is difficult that the end of the sampling time period coincides with the ideal end of the sampling time period.

Therefore, when the ideal sampling time period is shorter than the real sampling time period, the sampling data sampled from the end of the ideal sampling time period to the end of the real sampling time period is collected unnecessarily as the surplus sampling data. In contrast, when the ideal sampling time period is longer than the real sampling time period, sampling data becomes deficient in a period from the end of the real sampling time period to the end of the ideal sampling time period.

Similarly, as shown in FIG. 4B, even when the end of the sampling time period coincides with the ideal end, it is difficult that the start of the sampling time period coincides with the ideal start of the sampling time period.

Therefore, when the ideal sampling time period is shorter than the real sampling time period, the sampling data sampled from the start of the ideal sampling time period to the start of the real sampling time period is collected unnecessarily as the surplus sampling data. In contrast, when the ideal sampling time period is longer than the real sampling time period, sampling data becomes deficient in a time period from the start of the real sampling time period to the start of the ideal sampling time period.

In this manner, when the ideal sampling time period and the real sampling time period are shifted from each other, the sampling data sampled near both the ends of the sampling time period becomes the surplus sampling data, or the sampling data that should have been sampled near both the ends of the sampling time period becomes deficient. Consequently, the effective values calculated from the sampling data sampled in each sampling time period become erroneous.

An explanation is given above of situations in which either the start or the end of the real sampling time period coincides with the start or the end of the ideal sampling time period; however, in actual practice, both the start and the end of the real sampling time period shift from the start and the end of the ideal sampling time period, and the shift length also differs for each of the sampling time periods. That is, the influence of the sampling data on the start side and the end side of the sampling time period on the effective values differs for each of the sampling time periods.

The effective value calculation unit 15a is explained by referring to FIG. 3 once again. The effective value calculation unit 15a is a processing unit that performs processing such as acquiring of the sampling data from the AD converter 14 and calculation of the effective values. Concretely, the effective value calculation unit 15a includes the data acquiring unit 150a and the calculation unit 150b. The data acquiring unit 150a is a processing unit that acquires from the AD converter 14 the sampling data that is sampled in each of the sampling time periods. The data acquiring unit 150a passes the acquired sampling data to the calculation unit 150b.

As explained above, the sampling data sampled in each of the sampling time periods may contain the surplus sampling data in a portion near the start or the end of the sampling time period. Similarly, the sampling data may be deficient in each of the sampling time periods in a portion near the start or the end of the sampling time period.

The calculation unit 150b is a processing unit that generates weighted sampling data for each of the sampling time periods by multiplying a specific weight function by the sampling data sampled in each of the sampling time periods, and then calculates effective values for each of the sampling time periods from the weighted sampling data. An example of application of the weight function to the sampling data is explained below with reference to FIGS. 5A to 5C. FIGS. 5A and 5B depict an example when the Hanning window function is applied to the sampling data, and FIG. 5C depicts an example when some other weight function is applied.

In FIG. 5A, the sampling data acquired from the data acquiring unit 150a is shown with solid circles, and in FIG. 5B, the sampling data after multiplied by the Hanning window function is shown with crosses. In FIGS. 5A and 5B, the straight lines each connecting adjacent sampling data are shown only for the purpose of the explanation.

As shown in FIGS. 5A and 5B, the calculation unit 150b multiplies the Hanning window function by the sampling data sampled in the same sampling time period. The Hanning window function is a window function represented by Equation (1).

$$w ( x ) = 0.5 - 0.5 cos ( \frac{2 π x}{N} ) \qquad ( 1 )$$

In Equation (1), “x” represents x-coordinate of the sampling data, where the X axis is the horizontal axis, when a start of the sampling data is taken as 0 and a sampling interval is taken as 1, and “N” represents the total number of the sampling data.

In this manner, when the calculation unit 150b multiplies the sampling data by the Hanning window function, values of the sampling data sampled near both the ends of the sampling time period become smaller. Consequently, for example, even if the surplus sampling data exists near the end of the sampling time period as shown in FIG. 5A (see (a) in FIG. 5A), the values of the surplus sampling data can be made smaller (see (b) in FIG. 5B).

Meanwhile, any function can be used as the weight function as long as it gives the sampling data sampled near both the ends of the sampling time period less weight on the result than the other sampling data. Particularly, it is preferable to use a function after application such that the values of the sampling data near the start and the end of the sampling time period become zero. By using such a weight function, the influence of the sampling data at the start and the end of the sampling time period can be eliminated, and as a result, more accurate output results can be obtained. As such a weight function, for example, the triangular function (Bartlett window function) can be used (see FIG. 5C).

Moreover, a weight function whose slope becomes less steep toward the start and the end of the sampling time period can be used. By using such a weight function, the influence of the sampling data near both the ends of the sampling time period can be reduced, and as a result, even more accurate output results can be obtained. As such a weight function, for example, other than the Hanning window function shown in FIGS. 5A and 58, the Hann window function, the Blackman window function, or the standard normal distribution (the Gaussian function) can be used (see FIG. 5C).

It is desirable that the weight function is symmetric about a center of the sampling time period. The reason for this is that, as explained above, the degree of the influence on the effective values of the sampling data sampled near the start and near the end of the sampling time period, respectively, is different.

That is, in a sampling time period the influence of the sampling data sampled near the start of the sampling time period may be larger, and in other sampling time periods the influence of the sampling data sampled near the end of the sampling time period may be larger. Thus, there are situations in which it is not clear which of the sampling data, i.e., the sampling data sampled near the start or the sampling data sampled near the end, has a larger influence on the effective values. Even in these situations, accurate output results can be obtained by using the weight function that is symmetric about the center of the sampling time period.

Subsequently, the calculation unit 150b calculates the effective values of the detection signal from the weighted sampling data that is weighted with the Hanning window function. Concretely, the calculation unit 150b performs both, the weighting of the sampling data and the calculation of the effective values from the weighted sampling data, by using Equation (2).

$${v}_{rms} = \sqrt{\frac{1}{N} {\sum }_{i = 0}^{N - 1} {\vert w ( i ) f ( i ) \vert}^{2}} \qquad ( 2 )$$

In Equation (2), where “f(i)” represents a value of the sampling data at the horizontal position “(i) in a coordinate system. The calculation unit 150b outputs the effective values calculated by using Equation (2) to a control unit of the coin recognition device 10.

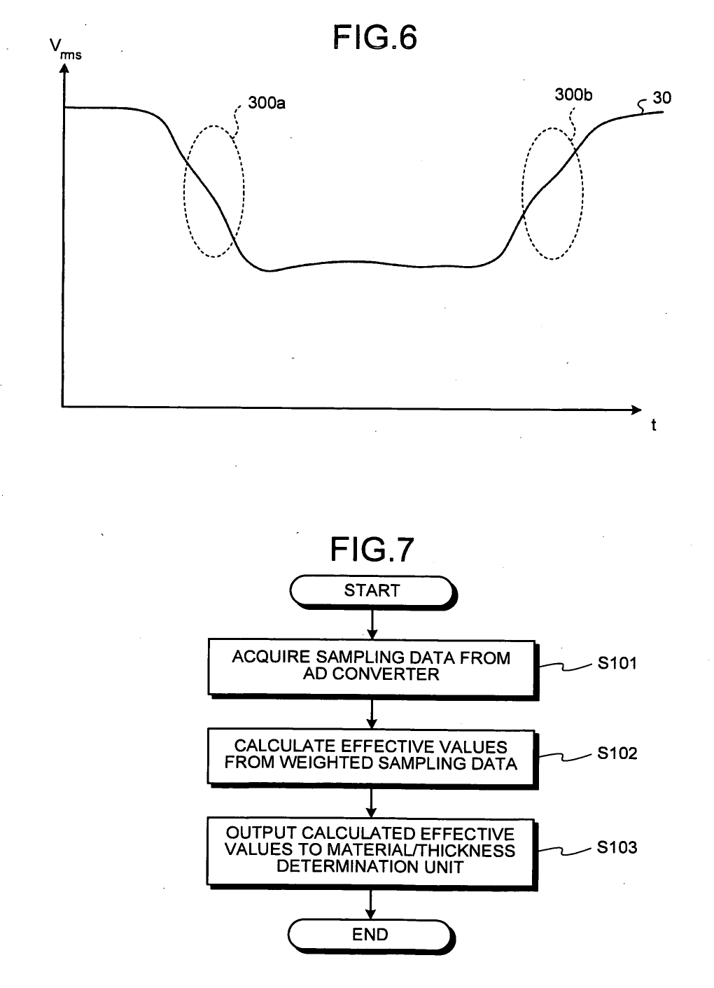

FIG. 6 depicts an example of an output waveform of the material/thickness sensor 11 obtained from the effective values. In FIG. 6, the effective values (Vᵣₘₛ) are plotted on a vertical axis and time is plotted on a horizontal axis. As a result, an output waveform 30 shown in FIG. 6 is obtained from the effective values output from the material/thickness sensor 11. The control unit (a material/thickness determination unit 15b explained later with reference to FIG. 9) of the coin recognition device 10 calculates plural evaluation values from the output waveform 30.

Concretely, the material/thickness determination unit 15b calculates the evaluation values relating to a thickness of an edge portion of the coin 100 from an area 300a or an area 300b shown in FIG. 6. The area 300a represents a change in the effective values when the coin 100 enters, and the area 300b represents a change in the effective values when the coin 100 exits. Concretely, the material/thickness determination unit 15b calculates a derivative value of the effective values in the area 300a, obtains plural local maximum values and plural local minimum values, and treats a difference value representing a difference between a highest local maximum value and a lowest local minimum value as the evaluation value of the area 300a. The material/thickness determination unit 15b calculates the evaluation value of the area 300b in the similar manner.

In this manner, because the evaluation values are calculated from fractional differences among the effective values, the evaluation values are greatly influenced when there is a large error in the effective values. In the present embodiment, the accuracy in the calculation of the effective value is improved by applying the weight function to the sampling data; therefore, the evaluation values can be calculated accurately, and consequently, the accuracy in the recognition of the coin 100 is improved.

A concrete operation of the effective value calculation unit 15a according to the present embodiment is explained below by using FIG. 7. FIG. 7 is a flowchart of the operations of the effective value calculation unit 15a. Among an entire processing performed by the effective value calculation unit 15a, a processing for calculating one effective value and outputting the calculated effective value to the material/thickness determination unit 15b is only shown in FIG. 7.

As shown in FIG. 7, the data acquiring unit 150a of the effective value calculation unit 15a acquires the sampling data from the AD converter 14 (Step S101) and passes the acquired sampling data to the calculation unit 150b. Subsequently, upon receiving all the sampling data sampled in the same sampling time period, the calculation unit 150b performs weighting of the acquired sampling data by using the weight function, thereby obtaining the weighted sampling data, and calculates the effective value from the weighted sampling data (Step S102).

The calculation unit 150b outputs the calculated effective value to the material/thickness determination unit 15b (Step S103), and the processing is terminated. In actual practice, the processing at Step S102 includes performing calculations based on Equation (2) by using the sampling data sampled in the same sampling time period. A determination as to whether the entire sampling data sampled in the same sampling time period has been acquired from the data acquiring unit 150a can be made, for example, based on whether a specific time frame is over from a time point at which the first sampling data is acquired, or based on whether a specific number of sampling data has been acquired.

Meanwhile, in FIGS. 5A and 5B, although the center of the sampling time period coincides with a peak of a valley of the detection signal, the two may not always coincide. The center of the sampling time period may coincide with a halfway of the valley of the detection signal. This happens because the frequency of the detection signal fluctuates, or because the start of the sampling time period is decided simply from time interval.

A portion near the center of the sampling time period is a portion where larger weight function is provided. Therefore, when the output waveform in the portion near the center of the sampling time period differs for each of the sampling time periods, it could produce an adverse effect on the accuracy in the calculation of the effective values. To take care of this issue, the sampling time period can be reset so that the center of the sampling time period coincides with a reference position (for example, a peak of mountain or valley of the waveform). This can be achieved by memory search; because, the signals are already loaded on a memory unit.

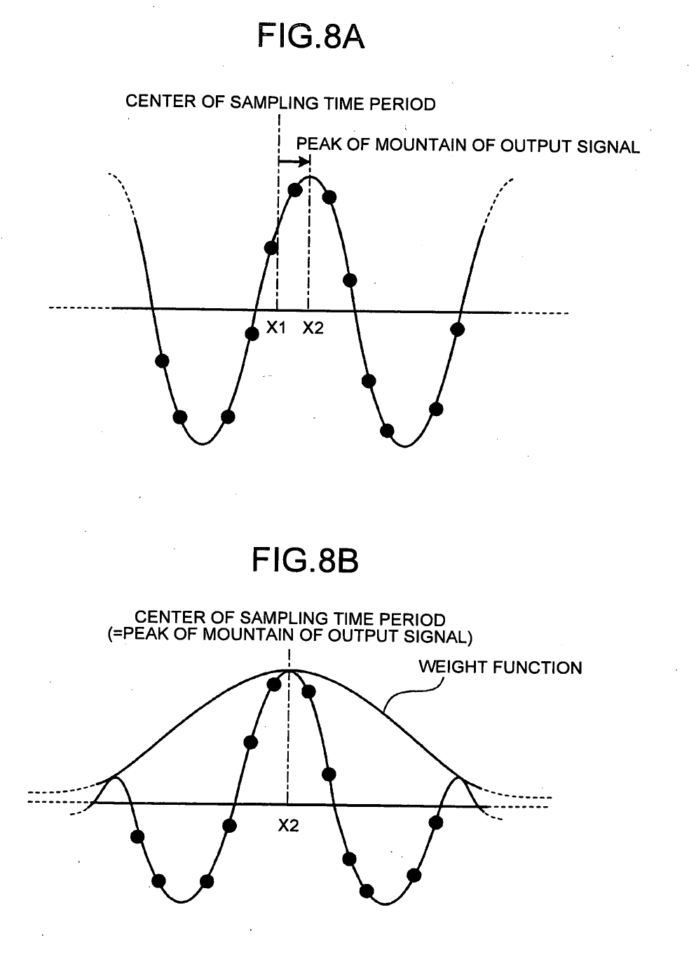

This point is explained by using FIGS. 8A and 8B. FIGS. 8A and 8B are diagrams for explaining the re-setting of the sampling time period. FIG. 8A depicts an operation of having the center of the sampling time period coincide with a peak of a mountain of the detection signal, and FIG. 8B depicts an operation of applying the weight function in a state in which the center of the sampling time period coincides with the peak of the mountain of the detection signal.

It is assumed that, the AD converter 14 always samples the detection signal output from the LC oscillation circuit 11c and outputs the acquired sampling data to the data acquiring unit 150a. Moreover, the data acquiring unit 150a stores the sampling data output from the AD converter 14 into a specific memory unit and reads out the sampling data of a specific period from the memory unit. That is, a time span between a start and an end of the sampling data read out by the data acquiring unit 150a corresponds to the sampling time period.

As shown in FIG. 8A, when the sampling data positioned at the center of the sampling time period among the sampling data read out from the memory unit does not coincide with the peak of the mountain of the detection signal, the data acquiring unit 150a resets the sampling time period so that the two coincide with each other. In other words, the data acquiring unit 150a re-reads out the sampling data from the memory unit.

Concretely, the data acquiring unit 150a first virtually restores the detection signal (analog signal) output from the LC oscillation circuit 11c by performing interpolation of the read-out sampling data, and identifies a peak of a mountain of the detection signal that is located most near the center of the sampling time period. For example, as shown in FIG. 8A, when the center of the sampling time period is located at a coordinate X1, the data acquiring unit 150a identifies a coordinate X2 of a peak of a mountain of the detection signal that is located most near the coordinate X1.

The data acquiring unit 150a then resets the sampling time period so that the center of the newly set sampling time period coincides with the coordinate X2. Concretely, the data acquiring unit 150a shifts the sampling time period in the horizontal axis direction until the center of the sampling time period coincides with the peak of the mountain of the detection signal. For example, in the example shown in FIG. 8A, the data acquiring unit 150a shifts the sampling time period by an amount equivalent to the amount of X2−X1. The data acquiring unit 150a then re-reads out the sampling data corresponding to the newly set sampling time period from the sampling data that has been stored in the memory unit and passes the read out sampling data to the calculation unit 150b.

With this processing, as shown in FIG. 8B, it is possible to have the center of the sampling time period to constantly coincide with the peak of the mountain of the detection signal. Consequently, the chances that the waveforms of the portion near the center of the sampling time period, which is a portion where larger weight function is provided, shift for each of the sampling time periods can be eliminated. Therefore, the effective values can be calculated accurately.

A configuration of the coin recognition device 10 according to the present embodiment is explained below. FIG. 9 is a block diagram of the configuration of the coin recognition device 10. Only those structural elements that are necessary for explaining features of the coin recognition device 10 are shown in FIG. 9, and general structural elements have been omitted.

As shown in FIG. 9, the coin recognition device 10 includes the material/thickness sensor 11, the magnetic sensor 12, the milled-edge sensor 13, the AD converter 14, and the control unit 15. The control unit 15 includes the effective value calculation unit 15a, the material/thickness determination unit 15b, a milled-edge calculation unit 15c, and a coin identification unit 15d. The effective value calculation unit 15a, as shown in FIG. 3, includes the data acquiring unit 150a with the memory unit, and the calculation unit 150b.

The magnetic sensor 12 is a sensor that detects a diameter of the coin 100. Concretely, the magnetic sensor 12 outputs a sensor output as a detection result relating to the diameter of the coin 100 from the detections of the aligning side transmissive sensor 12a and the counter-aligning side transmissive sensor 12b to the coin identification unit 15d, by applying a signal to the excitation coil 12c. The milled-edge sensor 13 outputs a sensor output detected by the reflective photosensor as a detection result relating to the milled edge to the milled-edge calculation unit 15c. The coin identification unit 15d identifies the coin 100 based on output results received from the material/thickness determination unit 15b, the milled-edge calculation unit 15c, and the magnetic sensor 12.

The control unit 15 is a processing unit that performs a material/thickness determination processing, a coin recognition processing, and the like, based on an output result (effective values) received from the material/thickness sensor 11. The effective value calculation unit 15a, as explained above, is a processing unit that performs acquiring of the sampling data output from the AD converter 14, storing of the acquired sampling data into the memory unit, calculation of the effective values, and the like.

The material/thickness determination unit 15b is a processing unit that determines the material/thickness of the coin 100 based on the effective values calculated by the effective value calculation unit 15a. Concretely, the material/thickness determination unit 15b calculates plural evaluation values relating to the thickness of the coin 100 based on the output waveform (see FIG. 6) of the effective values and passes the calculated evaluation values to the coin identification unit 15d. The milled-edge calculation unit 15c is a processing unit that calculates an evaluation value relating to the milled edge of the coin 100 from the output result received from the milled-edge sensor 13.

The coin identification unit 15d is a processing unit that identifies the coin 100 by performing the multivariate analysis based on the evaluation values received from the material/thickness determination unit 15b or the output result received from the other sensors.

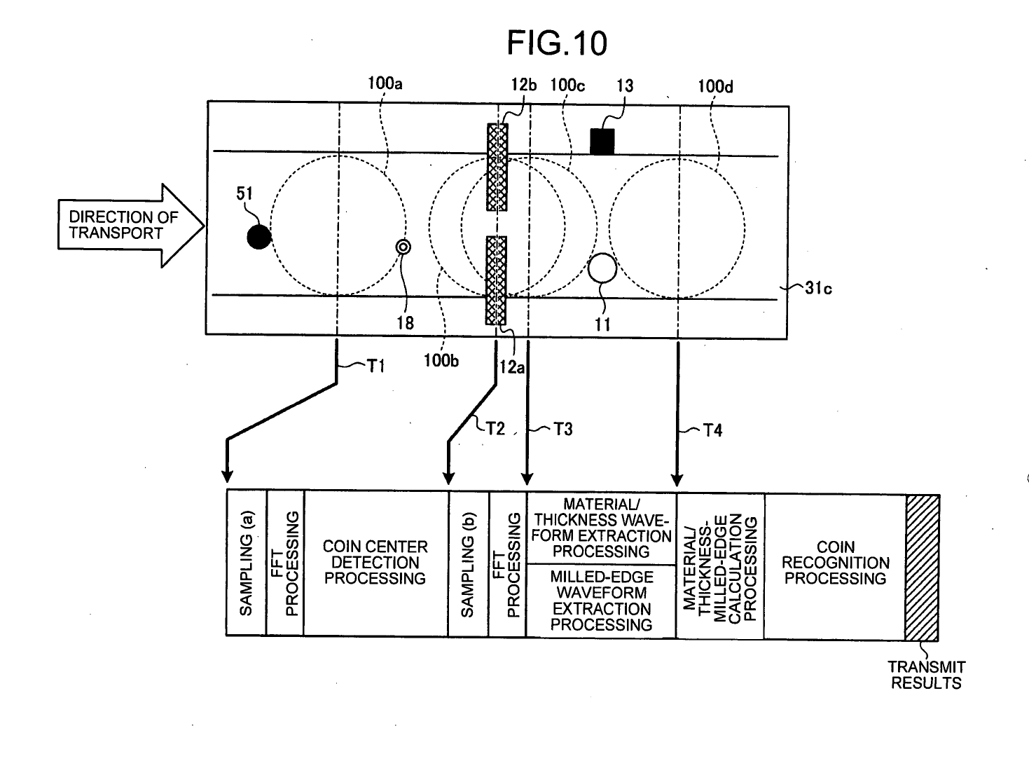

A concept of the processing performed by the coin recognition device 10 is explained below. FIG. 10 is a diagram for explaining the concept of the processing performed by the coin recognition device 10. An upper part of FIG. 10 is a schematic diagram of the coin recognition device 10 when seen from the same direction as that of FIG. 2A, and a lower part of FIG. 10 is a timing chart of the various processing performed by the coin recognition device 10.

As shown in the upper part of FIG. 10, at a timing at which the coin 100 is supported by a transport pin 51 reaches a position 100a, i.e., a timing (timing T1) at which the coin 100 reaches a position of a timing sensor 18, the excitation coil 12c performs a three-frequency synthesizing oscillation in response to an instruction from the control unit 15. The three-frequency synthesizing oscillation means an oscillation based on a synthesis of a high frequency (for example, 250 kHz), an intermediate frequency (for example, 16 kHz), and a low frequency (for example, 4 kHz).

As shown in the lower part of FIG. 10, the aligning side transmissive sensor 12a and the counter-aligning side transmissive sensor 12b perform sampling (a) of a three-frequency-synthesized signal. Subsequently, the control unit 15 extracts a detection signal corresponding to each of the three frequencies by performing a fast Fourier transform (FFT) processing on the data obtained in the sampling (a). Meanwhile, amplitudes of each of the specific frequencies obtained in the FFT processing are used as reference values representing a situation in which the coin 100 is not present at a position where the magnetic sensor 12 has been mounted.

The excitation coil 12c performs a single-frequency oscillation in response to an instruction from the control unit 15 upon completion of a period of the three-frequency synthesizing oscillation. With this operation, as shown in the lower part of FIG. 10, a coin center detection processing is performed by the control unit 15. Concretely, amplitude of excitation signals start reducing when an edge of the coin 100 reaches the magnetic sensor 12. A change rate of the amplitude becomes zero when a center of the coin 100 coincides with a center of the magnetic sensor 12. The control unit 15 detects a timing, i.e., a local minimum value of the amplitude, at which the change rate becomes zero by monitoring the change rate of the amplitude.

Subsequently, as shown in the upper part of FIG. 10, when the coin reaches a position 100b, i.e., when the control unit 15 detects a timing (timing T2) at which the center of the coin 100 reaches a position at which it coincides with the center of the magnetic sensor 12, the excitation coil 12c performs the three-frequency combined oscillation in response to an instruction from the control unit 15.

As shown in the lower part of FIG. 10, sampling (b) is performed with respect to the aligning side transmissive sensor 12a and the counter-aligning side transmissive sensor 12b. Subsequently, the control unit 15 performs the FFT processing on the data obtained in the sampling (b). Meanwhile, amplitudes of each of the specific frequencies obtained in the FFT processing are used as measured values representing a situation in which the center of the coin 100 coincides with the center of the magnetic sensor 12.

Subsequently, as shown in the upper part of FIG. 10, when the coin reaches a position 100c, i.e., when the control unit 15 detects a timing (timing T3) at which the coin 100 reaches a position of the material/thickness sensor 11, a material/thickness waveform extraction processing is performed by the material/thickness sensor 11 and a milled-edge extraction processing is performed by the milled-edge sensor 13. The material/thickness waveform extraction processing corresponds to Steps S101 to S103 shown in FIG. 7.

Subsequently, as shown in the upper part of FIG. 10, when the coin reaches a position 100d, i.e., when the control unit 15 detects a timing (timing T4) at which the coin 100 goes out of a detection range of the material/thickness sensor 11, a material/thickness determination processing is performed by the material/thickness determination unit 15b and a milled-edge calculation processing is performed by the milled-edge calculation unit 15c (material/thickness/milled-edge calculation processing). Concretely, the material/thickness determination unit 15b calculates the evaluation values relating to the material/thickness of the coin 100 from the output result (effective values) received from the material/thickness sensor 11, and calculates the evaluation values relating to the milled edge from the output result received from the milled-edge sensor 13.

When the material/thickness and milled-edge calculation processing are completed and the calculated evaluation values are output to the coin identification unit 15d, the coin identification unit 15d identifies the coin 100 by performing the multivariate analysis based on the evaluation values and the output result received from the magnetic sensor 12 and transmits the result of the recognition.

Concretely, the coin identification unit 15d identifies denominations and authenticity of the coin 100 by employing the so called Mahalanobis' distance. The Mahalanobis' distance is a distance that takes into account a stochastic distribution and it is typically used in a multivariate analysis using correlation among multiple variables. In the present embodiment, the Mahalanobis' distance is calculated by using the evaluation values calculated at the material/thickness and milled-edge calculation processing and the output results of the magnetic sensor 12.

An example of a denomination discrimination based on the multivariate analysis by employing the Mahalanobis' distance is explained below with reference to FIG. 11. FIG. 11 depicts an example of the denomination discrimination based on the multivariate analysis by employing the Mahalanobis' distance. In FIG. 11, open circles represent sample values of a denomination A, and crosses represent sample values of a denomination B. Variables obtained by the various sensors (for example, the evaluation values) are plotted on an X axis and a Y axis system in FIG. 11.

As shown in FIG. 11, in the denomination discrimination employing the Mahalanobis' distance, a region inside a closed curved line having a distribution center 71 is a range of the denomination A (see “range of denomination A” in FIG. 11) and a region inside a closed curved line having a distribution center 72 is a range of the denomination B (see “range of denomination B” in FIG. 11). The coin identification unit 15d determines that the coin 100 is the denomination A when coordinates of a variable corresponding to the X axis and the Y axis fall in the range of the denomination A, and determines that the coin 100 is the denomination B when the coordinates fall in the range of the denomination B.

A two-dimensional information space is used here to give the explanation in order to make the explanation simple; however, the dimensions of the information space can be adjusted depending on number of variables obtained from the various sensors. In other words, a ten-dimensional information space is used when the number of variables obtained from the various sensors is 10.

In this manner, the coin recognition device 10 recognizes the coin 100 by performing the multivariate analysis by using correlations among the evaluation values or the output results obtained from the various sensors. When doing so, the coin recognition device 10 calculates the evaluation values relating to the material and thickness of the coin 100 by using the highly-accurate effective values that have been calculated by applying the window function, and these evaluation values are used as the variables in the multivariate analysis; therefore, the accuracy in the recognition of the coin 100 can be improved.

As explained above, in the present invention, the AD converter 14 samples the detection signal output from the self-oscillation type LC oscillation circuit 11c at the specific sampling interval, the data acquiring unit 150a acquires the sampling data sampled in the specific period and stores the acquired sampling data in the memory unit, the calculation unit 150b reduces the weight on the sampling data sampled near both the ends of the sampling time period than the weight on the other sampling data and calculates the effective values of the detection signal from the weighted sampling data. As a result, highly-accurate output results can be obtained when not only the amplitude of the output signal but also the frequency of the output signal fluctuates.

In this manner, the coin sensor, the effective value calculation method, and the coin recognition device according to the present invention is effective in obtaining the highly-accurate output results even when the frequency of the output signal fluctuates, and these are particularly suitable in a situation in which the recognition of the coins is performed by using plural sensors including the coin sensor.

According to an aspect of the present invention, an output signal output from a self-oscillating circuit is sampled at a specific sampling interval; sampling data sampled in a specific sampling time period is acquired; among the acquired sampling data, a weight on the sampling data sampled near both ends of the specific sampling time period is reduced than a weight on other sampling data; and effective values of an output signal in the specific sampling time period are calculated from the weighted sampling data. As a result, highly-accurate output results can be obtained even when a frequency of an output signal fluctuates.

Furthermore, according to another aspect of the present invention, weighting of the sampling data is performed by applying a weight function whose slope becomes less steep toward a start and an end of the specific sampling time period to the sampling data. As a result, because differences between values of the sampling data sampled near both the ends of the sampling time period and values of the other sampling data increases, still more accurate output results can be obtained.

Moreover, according to still another aspect of the present invention, weighting of the sampling data is performed by applying the weight function that makes values of the sampling data near the start and the end of the specific sampling time period zero. As a result, because the values of the sampling data sampled at the start and the end of the sampling time period, i.e., the sampling data that most readily introduces an error in the calculated effective values, become zero, still more accurate output results can be obtained.

Furthermore, according to still another aspect of the present invention, the weight function is symmetric on a right side and a left side of a center of the specific sampling time period as a reference. As a result, even when a degree of an influence on the effective values of the sampling data sampled at the start and/or the end of the sampling time period is different, accurate output results can be obtained stably.

In this embodiment, the thickness and material of the coin are handled together, however, the thickness can be handled independently by this sensor device 10. Similarly, the material can be handled independently by the device 10.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A coin sensor that magnetically detects a property of a coin, the coin sensor comprising:
a self-oscillating circuit;
a sampling unit that samples an output signal output from the self-oscillating circuit at a specific sampling interval;
a data acquiring unit that acquires sampling data sampled by the sampling unit in a specific sampling time period;
a weighting unit that, among the sampling data acquired by the data acquiring unit, reduces a weight on the sampling data sampled near both ends of the specific sampling time period than a weight on other sampling data and outputs weighted sampling data; and
an effective value calculation unit that calculates effective values of the output signal in the specific sampling time period from the weighted sampling data.

2. The coin sensor according to claim 1, wherein the weighting unit performs weighting of the sampling data by applying a weight function whose slope becomes less steep toward a start and an end of the specific sampling time period to the sampling data.

3. The coin sensor according to claim 1, wherein the weighting unit performs the weighting of the sampling data by applying the weight function that makes values of the sampling data at the start and the end of the specific sampling time period zero.

4. The coin sensor according to claim 2, wherein the weight function is symmetric about a center of the specific sampling time period.

5. An effective value calculation method comprising:
sampling an output signal output from a self-oscillating circuit at a specific sampling interval;
acquiring sampling data sampled at the sampling step in a specific sampling time period;
reducing, among the sampling data acquired at the data acquiring step, a weight on the sampling data sampled near both ends of the specific sampling time period than a weight on other sampling data and outputting weighted sampling data; and
calculating effective values of the output signal in the specific sampling time period from the weighted sampling data.

6. A coin recognition device that includes plural types of sensors including a coin sensor, the coin recognition device comprising:
a sampling unit that samples an output signal output from a self-oscillating circuit in the coin sensor at a specific sampling interval;
a data acquiring unit that acquires sampling data sampled by the sampling unit in a specific sampling time period;
a weighting unit that, among the sampling data acquired by the data acquiring unit, reduces a weight on the sampling data sampled near both ends of the specific sampling time period than a weight on other sampling data and outputs weighted sampling data;
an effective value calculation unit that calculates effective values of the output signal in the specific sampling time period from the weighted sampling data;
a material/thickness determination unit that determines a material/thickness of the coin from the effective values calculated by the effective value calculation unit; and
a coin identification unit that identifies the coin by performing a multivariate analysis based on the material/thickness of the coin determined by the material/thickness determination unit and an output result of another sensor.
